(19) United States
(12) Patent Application Publication
(10) Pub. No.: US 2008/0155852 A1
(43) Pub. Date: Jul. 3, 2008

(54) MULTIPLE SUBSTRATE VAPOR DRYING SYSTEMS AND METHODS

(76) Inventors: DONALD J.K. OLGADO, Palo Alto, CA (US); Simon Yavelberg, Cupertino, CA (US); Edwin Velaquez, (US); Hui Chen, Burlingame, CA (US); Sheshraj L. Tulshibagwale, Santa Clara, CA (US); Ho Seon Shin, Cupertino, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 11/967,533

(22) Filed: Dec. 31, 2007

Related U.S. Application Data
(60) Provisional application No. 60/882,894, filed on Dec. 29, 2006.

(51) Int. Cl. F26B 25/08; F26B 3/04

(52) U.S. Cl. 34/210; 34/209; 34/236

(57) ABSTRACT

Embodiments of the present invention generally relate to an apparatus and methods for rinsing and drying substrates that include multiple rinsing and drying modules. Methods for arranging drying modules to enable high-throughput rinsing and drying of multiple substrates are also provided. In one embodiment a system for drying semiconductor substrates is provided. The system comprises a housing, a first drying module positioned within the housing, and a second drying module positioned adjacent the first drying module within the housing, wherein the first and second drying modules are oriented approximately vertically within the housing.

### CROSS-REFERENCE TO RELATED APPLICATIONS

This application claims benefit of U.S. provisional patent application Ser. No. 10/882,894, filed Dec. 29, 2006, which is herein incorporated by reference.

### BACKGROUND OF THE INVENTION

1. Field of the Invention

Embodiments of the present invention generally relate to an apparatus and methods for rinsing and drying substrates that include multiple rinsing and drying modules.

2. Description of the Related Art

As semiconductor device geometries continue to decrease, the importance of ultra clean processing increases. Aqueous cleaning within a tank of fluid (or a bath) followed by a rinsing bath (e.g., within a separate tank, or by replacing the cleaning tank fluid) achieves desirable cleaning levels. After removal from the rinsing bath, absent use of a drying apparatus, the bath fluid evaporates from the substrate's surface causing streaking, spotting and/or leaving bath residue on the surface of the substrate. Such streaking, spotting and residue can cause subsequent device failure. Accordingly, much attention has been directed to improved methods for drying a substrate as it is removed from an aqueous bath.

A method known as Marangoni drying creates a surface tension gradient to induce bath fluid to flow from the substrate in a manner that leaves the substrate virtually free of bath fluid, and thus may avoid streaking, spotting and residue marks. Specifically, during Marangoni drying a solvent miscible with the bath fluid (e.g., isopropyl alcohol (IPA) vapor) is introduced to a fluid meniscus which forms as the substrate is lifted from the bath or as the bath fluid is drained past the substrate. The solvent vapor is absorbed along the surface of the fluid, with the concentration of the absorbed vapor being higher at the tip of the meniscus. The higher concentration of absorbed vapor causes surface tension to be lower at the tip of the meniscus than in the bulk of the bath fluid, causing bath fluid to flow from the drying meniscus toward the bulk bath fluid. Such a flow is known as “Marangoni” flow, and can be employed to achieve substrate drying without leaving streaks, spotting or bath residue on the substrate.

The effectiveness of a substrate fabrication process is often measured by two related and important factors, which are device yield and the cost of ownership (CoO). These factors are important since they directly affect the cost to produce an electronic device and thus a device manufacturer's competitiveness in the market place. The CoO, while affected by a number of factors, is greatly affected by the system and chamber throughput, or simply the number of substrates per hour processed using a desired processing sequence. In an effort to reduce CoO, electronic device manufacturers often spend a large amount of time trying to optimize the process sequence and chamber processing time to achieve the greatest substrate throughput possible given the tool architecture limitations and the chamber processing times.

For the foregoing reasons, there is a need for a tool that can meet the required device performance goals, has a high substrate throughput, and thus reduces the process sequence CoO.

### SUMMARY OF THE INVENTION

Embodiments of the present invention generally relate to an apparatus and methods for rinsing and drying substrates that include multiple rinsing and drying modules. Methods for arranging drying modules to enable high-throughput rinsing and drying of multiple substrates are also provided. In one embodiment a system for drying semiconductor substrates. The system comprises a housing, a first drying module positioned within the housing, and a second drying module positioned adjacent the first drying module within the housing, wherein the first and second drying modules are oriented approximately vertically within the housing.

In another embodiment a system for drying semiconductor substrates is provided. The system comprises a housing comprising at least one sidewall and a bottom, a first drying module positioned within the housing, a second drying module positioned adjacent the first drying module within the housing, wherein the first and second drying modules are oriented approximately vertically within the housing and side-by-side such that the respective frontal portions of the drying modules are parallel to each other, and the respective rear portions of the drying modules are parallel to each other.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of an embodiment of a multiple substrate drying apparatus according to an embodiment of the present invention;

FIG. 2 is a perspective view of the individual drying module with the front portion removed according to an embodiment of the present invention;

FIGS. 3A-3C are perspective views of an example embodiment of a drying module showing successive stages of a substrate input process according to an embodiment of the present invention;

FIGS. 4A-4D are perspective views of an example embodiment of a drying module showing successive stages of a substrate removal process according to an embodiment of the present invention;

FIG. 5 is a perspective view of another embodiment of a multiple substrate drying apparatus according to an embodiment of the present invention;

FIG. 6 is a cut-away perspective view of an embodiment of a drying module as may be used in the apparatus of FIG. 5;

FIGS. 7A-7C are perspective views of an example embodiment of a drying module showing successive stages a substrate input process according to an embodiment of the present invention; and

FIGS. 8A-8E are perspective views of an example embodiment of a drying module showing successive stages of a substrate removal process according to an embodiment of the present invention; and

FIG. 9 is a perspective view of an embodiment of a multiple substrate drying apparatus according to an embodiment of the present invention.

To facilitate understanding, identical reference numerals have been used, wherever possible, to designate identical elements that are common to the figures. It is contemplated that elements and/or process steps of one embodiment may be beneficially incorporated in other embodiments without additional recitation.

### DETAILED DESCRIPTION

The present invention provides apparatus for rinsing and drying substrates that include multiple rinsing and drying modules (hereinafter termed ‘drying modules’). Methods for arranging drying modules to enable high-throughput rinsing and drying of multiple substrates are also provided.

According to some embodiments of the present invention, two or more drying modules are positioned adjacent one other. The term ‘adjacent’ is defined herein to mean one or more of: attached to, closely adjoining, against and/or spaced a short distance from; accordingly, adjacent drying modules may be in contact and/or may be spaced a short distance from each other.

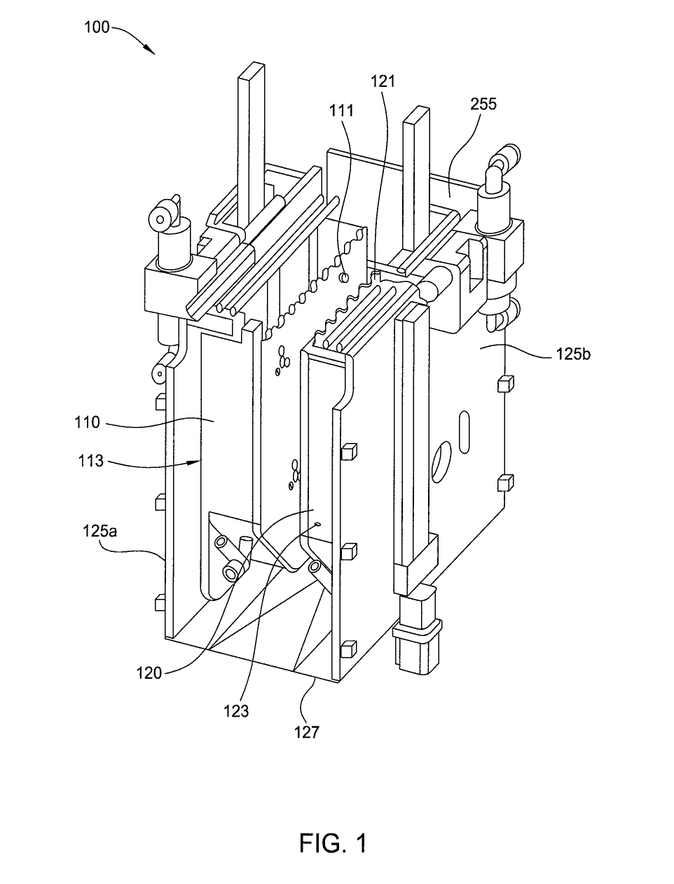

FIG. 1 is a perspective view of an embodiment of a multiple substrate drying apparatus 100 according to the present invention. The apparatus 100 includes two vertically arranged drying modules 110, 120, positioned adjacent each other. In the embodiment shown, the drying modules 110, 120 are mirrored such that the respective frontal portions 111, 121 of the drying modules face each other, and the respective rear portions 113, 123 of the drying modules face away from each other. The modules 110, 120 may be slightly angled with respect to a vertical axis, for example, between 1 and 1.5 degrees from vertical in some embodiments, and up to 8 to 10 degrees in other embodiments. While the embodiment depicted illustrates depicts a dual (two) module drying apparatus, more than two drying modules may be used. The apparatus 100 includes sidewalls 125a-b and a bottom 127 to which the drying modules 110, 120 are mounted. In some embodiments, the sidewalls 125a-b may serve as just mounting surfaces, which in other embodiments, the sidewalls 125a-b may serve as the rear sealing surface of each module 110, 120.

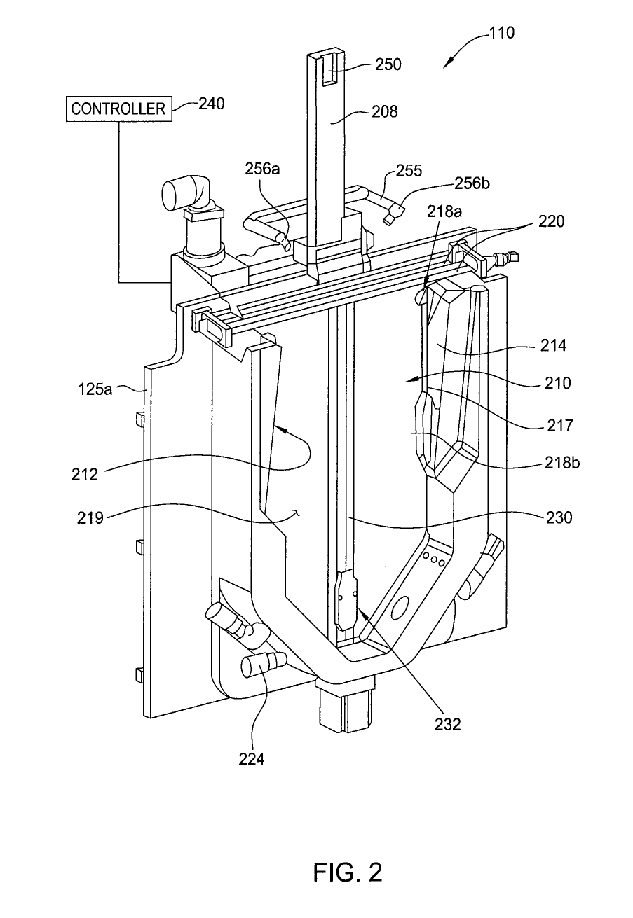

FIG. 2 is a perspective view of the individual drying module 110 with the front portion 111 removed according to an embodiment of the present invention. The drying module 110 is shown in the vertical orientation in which module 110 may be used in the multiple substrate drying apparatus 100 (FIG. 1). The drying module 110 is shown attached to sidewall 125a of the apparatus 100. As shown in FIG. 2, the drying module 110 includes a drying compartment 210 that has approximately the same length in the vertical direction as the sidewall 125a, and has width and depth dimensions that define a sufficient internal volume to hold a rinsing fluid and a substrate of a desired size to be dried.

The drying compartment 210 may be filled to a suitable vertical level with a rinsing fluid; the rinsing fluid may comprise deionized water (DIW), one or more solvents, or any other chemical useful for drying a substrate and/or rinsing films and/or particulates from a substrate. One or more drain conduits/or and valves 224 may be positioned toward the bottom of the drying compartment 210 to empty used rinsing fluid, allowing the compartment to be replenished with clean rinsing fluid from an intake manifold (not shown).

Lateral surfaces e.g., 212, 214 of the drying compartment 210 include an approximately vertically oriented groove 217 (which is depicted only on the right lateral side 214) adapted to receive substrate guides 218a-b (only visible on lateral surface 214 in FIG. 2). The groove 217 may be slightly angled from the vertical, for example, between about 1 to 1.5 degrees or at another suitable angle. Alternatively, as noted, the entire drying module 110 may be slightly angled within the drying apparatus 100. Each guide 218a-b may include any other device suitable for receiving the edge of a descending substrate and for supporting and/or positioning the substrate within the drying compartment 210. In some embodiments, the guides 218a-b may be V-shaped or U-shaped supporting surfaces, although other shapes may be used. The guides 218a-b may be stationary, or move within the groove 217. Similar guides may be used on the other lateral surface 212 of the drying compartment 210.

A backwall 219 of the drying compartment 210 includes a vertical rail 230 along which a movable carrier device 232 is adapted to move upward and downward (e.g., in response to signals transmitted from a controller 240). The movable carrier device 232 may include one or more grooves and/or grippers on its upper end to receive and/or secure a lower edge of a substrate.

One or more drying vapor conduits 220 may be positioned above the drying compartment 210 and coupled to the sidewall 125a. While two drying vapor conduits 220 are shown in FIG. 2, other numbers of conduits, including a single conduit, may be used. In some embodiments, each drying vapor conduit 220 may be oriented horizontally to cover the horizontal width of the drying compartment 210 and may include a number of downward oriented holes, nozzles or other fluid delivery mechanisms along a length of the conduit 220. In operation, when a drying vapor is supplied to the drying vapor conduits 220, the drying vapor is dispensed from the conduits toward a substrate positioned between the conduits 220 in the drying compartment 210. For example, a first of the conduits 220 may direct drying vapor toward a front side of a substrate while a second of the conduits 220 may direct fluid toward a backside of the substrate. As is known to those of skill in the art, the drying vapor may comprise isopropyl alcohol (IPA) and/or another chemical suitable for reducing surface tension between a substrate and rinsing fluid as the substrate is drawn out of the rinsing fluid.

A substrate sensor 250 may be coupled to the sidewall 125a, such as via as support member 208. The sensor 250 may comprise an infrared sensor or other suitable sensor adapted to determine whether a substrate surface is positioned in front of or in the vicinity of the sensor. In some embodiments, the substrate sensor 250 may be rotatable between a vertical, active position and a horizontal, inactive position.

A gripping mechanism 255 adapted to grip an edge of a substrate also may be coupled to the sidewall 125a and/or the support member 208 (see, for example, gripper 255 coupled to sidewall 125b in FIG. 1). The gripping mechanism 255 may comprise one or more pads, pincers or other gripping surfaces 256a-b for contacting and/or supporting a substrate being loaded into or unloaded from the drying compartment 210 (as described below). In some embodiments, the gripping mechanism 255 (and gripping surfaces 256a-b) may be adapted to move vertically, such as via rail or other guide (not shown), as a substrate is raised or lowered relative to the drying compartment 210.

A controller 240 may be employed to control operation of the drying modules, such as detecting presence of a substrate, raising/lowering a substrate, controlling delivery or removal of a substrate (via a robot), delivering/supplying of drying vapor during drying, and/or the like. The controller 240 may include one or more microprocessors, microcomputers, microcontrollers, dedicated hardware or logic, a combination of the same, etc.

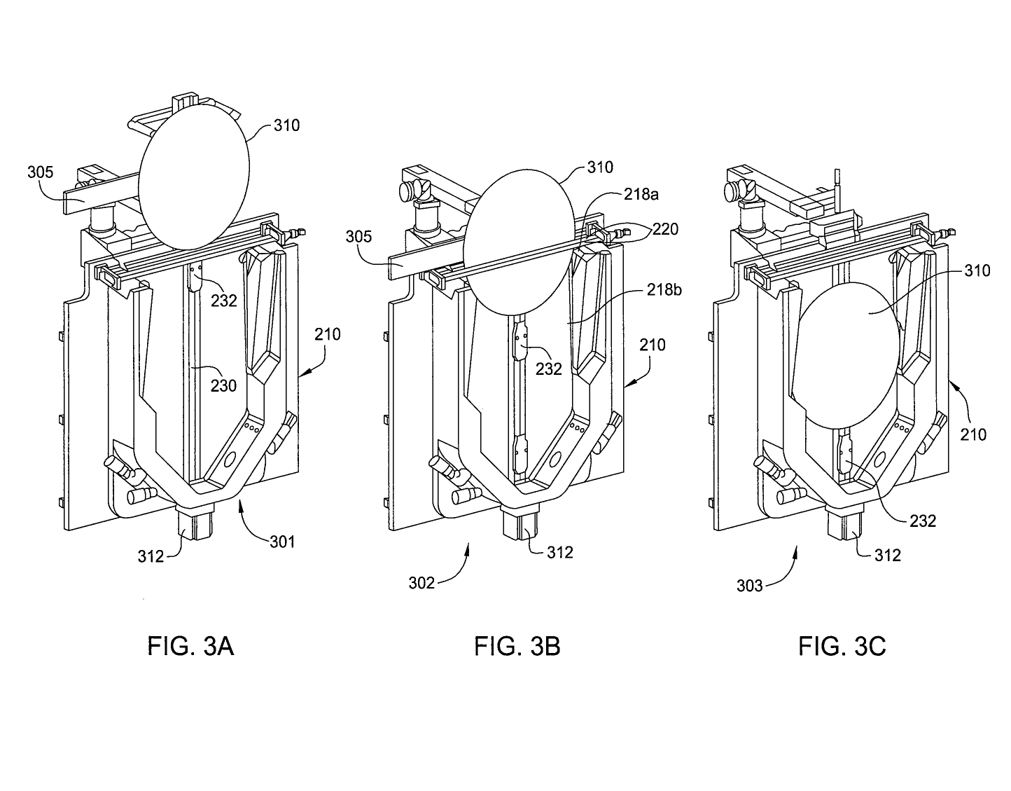

Operation of the drying module 100 during a substrate input process is described with reference to FIGS. 3A-3C which are perspective views of an example embodiment of a drying module, showing successive stages of a substrate input process. In operation, in a first stage 301 shown in FIG. 3A, a robot arm 305 which may enter the apparatus from another chamber (not shown) or external area (e.g., under command of the controller 240 (FIG. 2)) holds a substrate 310 in a vertical orientation and moves the substrate to a position directly above the drying compartment 210. The robot arm 305 may hold the substrate 310 securely by application of a vacuum to a set of holes on the robot arm's supporting surface (e.g., an end effector and/or blade), or via any other suitable mechanism such as releasable edge grippers that may be selectively and precisely activated and deactivated (e.g., via the controller 240) to secure or release a substrate. While the robot arm 305 holds the substrate 310 over the drying compartment 210, the carrier device 232 within the drying compartment 210 moves to the top of the rail 230 (via motor 312). In this position, the top of the carrier device 232 is positioned adjacent the bottom edge of the substrate 310.

In a second stage 302, shown in FIG. 3E, the robot arm 305 is shifted from its initial position downward toward the drying compartment 210 to lower the substrate 310 (with the carrier device 232) into the drying compartment 210 between the drying vapor conduits 220. The carrier device 232 may be lowered by motor 312 or passively forced downward by the action of the robot arm 305. As the substrate 310 descends between the drying vapor conduits 220, the substrate 310 is received at its edge by the guides 218a.

After the substrate 310 descends a predefined distance within the drying compartment 210, as determined by the position of the carrier device 232, for example, in third stage 303 (FIG. 3C), the robot arm 305 disengages from the substrate 310. Once the substrate 310 is disengaged, the carrier device 232 moves downward, bringing the substrate 310 further into the drying compartment 210 to a bottom position, as shown in FIG. 3C and into contact with guides 218b (FIG. 3B). In this bottom position, the substrate 310 may be completely submerged in rinsing fluid.

Once a predetermined time has elapsed and/or rinsing operations have been performed, the substrate 310 is lifted by the carrier device 232 from the bottom position. As the substrate 310 is lifted, the substrate 310 maintains a vertical or approximately vertical (e.g., between 1 and 1.5 degrees from vertical) orientation because the substrate's motion is constrained by the guides 218a and/or 218b. As the substrate 310 emerges from the rinsing fluid (which may be detected by the position of the carrier device 232, for example), the drying vapor conduits 220 spray drying vapor toward the substrate and rinsing fluid. As indicated, the drying vapor reduces surface tension between the substrate 310 and the rinsing fluid as the substrate emerges, which prevents a film of rinsing fluid from forming on and sticking to the substrate surface.

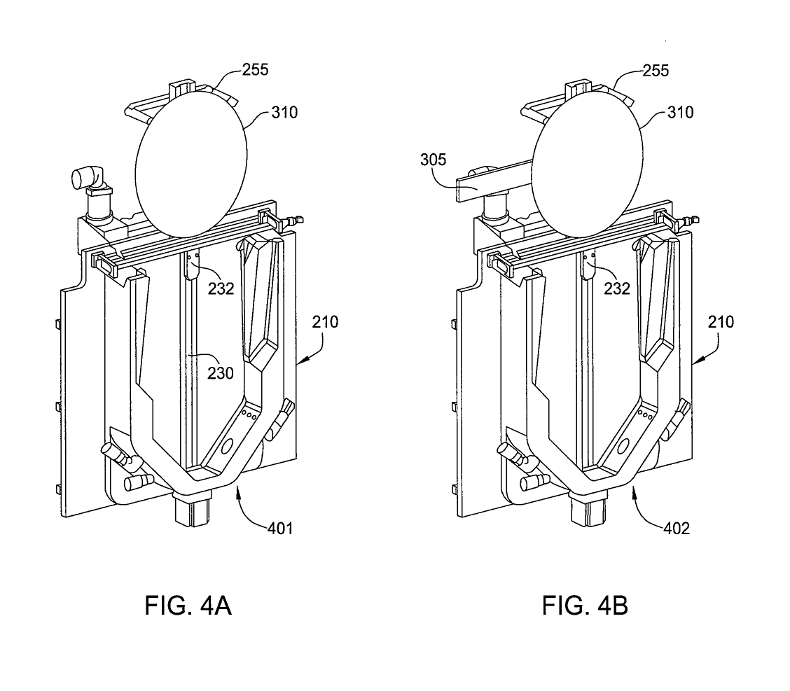

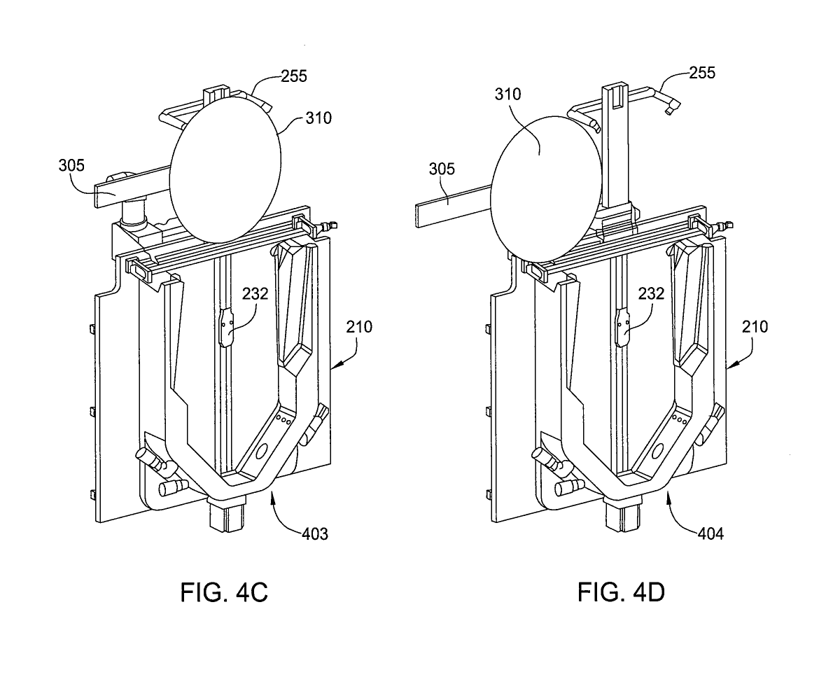

After the substrate 310 is rinsed and dried, it is removed from the drying compartment 210. Stages of this sequence are shown in FIGS. 4A-4D which are perspective views. During substrate removal, the carrier device 232 is moved upward, lifting the substrate as it travels along the rail 230. When the top of the substrate 310 has moved a certain distance out of the drying compartment 210 and has cleared the top edge of the drying compartment 210, the substrate 310 contacts the gripping device 255, which grips the edge of the substrate 310 as the carrier device 232 travels to the highest position at the top of the rail 230. At this stage 401, shown in FIG. 4A, the carrier device 232 is at the highest position, the substrate 310 is completely lifted out of the drying compartment 210 and the gripping device 255 contacts the top of the substrate 310. The substrate sensor 250 (FIG. 2) may detect when the substrate 310 has been lifted out of the drying compartment 210 to this level.

As shown in a second stage 402 in FIG. 4B, once the gripping device 255 contacts the substrate 310, the robot arm 305 (e.g., a blade of the robot arm) is moved into contact with one of the substrate's surfaces (e.g., a backside of the substrate 310). The securing mechanism (e.g., vacuum, electrostatic, etc.) of the robot arm 305 is then activated to adhere the robot arm 305 to the substrate 310. The carrier device 232 is lowered, and the robot arm 305 moves (e.g., horizontally) to remove the substrate 310 from the gripping device 255 as shown in a third stage 403 in FIG. 4C. Once the substrate 310 is removed from the gripping device 255, the robot arm 305 is moved in the direction of the arrow depicted to remove the substrate from the apparatus 100 as shown in a fourth stage 404 in FIG. 4D. The duration of the substrate removal process from stages 401 to 404 may be approximately 20 seconds in some embodiments, although longer or short times may be used. For example, removal may take more or less time depending on the speed of the robot arm.

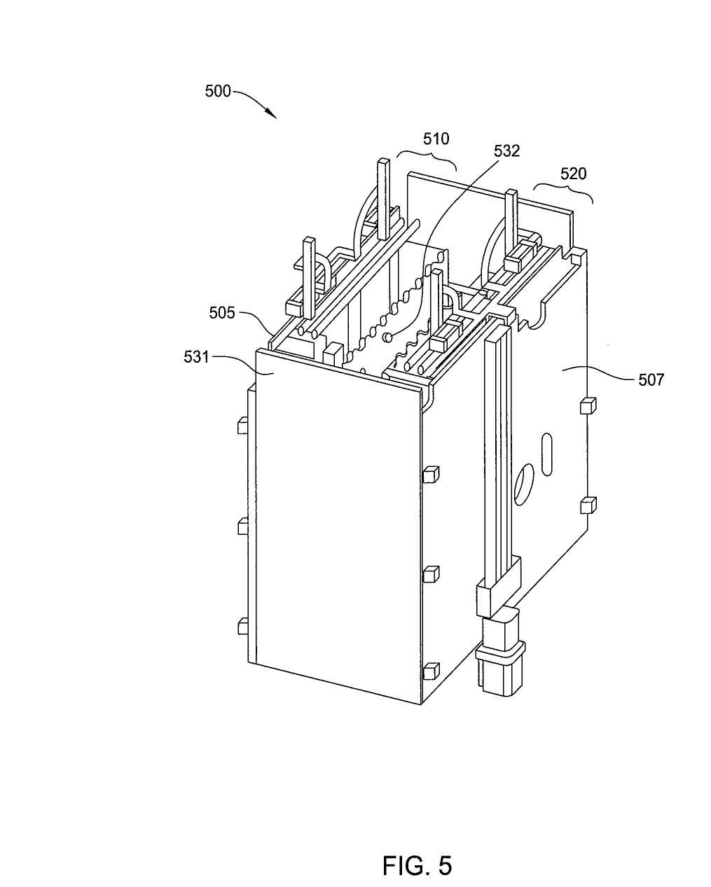

FIG. 5 is a perspective view of another embodiment of a multiple substrate drying apparatus 500 according to the present invention. The apparatus 500 includes two vertically-oriented drying modules 510, 520 positioned adjacent and facing one another as in the embodiment shown in FIG. 1. It is noted that the apparatus 500 may include more than two modules. In the depicted embodiment, both drying modules 510, 520 are affixed at their lateral (left and right) ends to connecting plates 531, 532 which form an enclosure with respective supporting plates 505, 507 of the drying modules. The modules 510, 520 may be slightly angled with respect to a vertical axis, for example, between about 1 and 1.5 degrees from vertical. Other angles may be used.

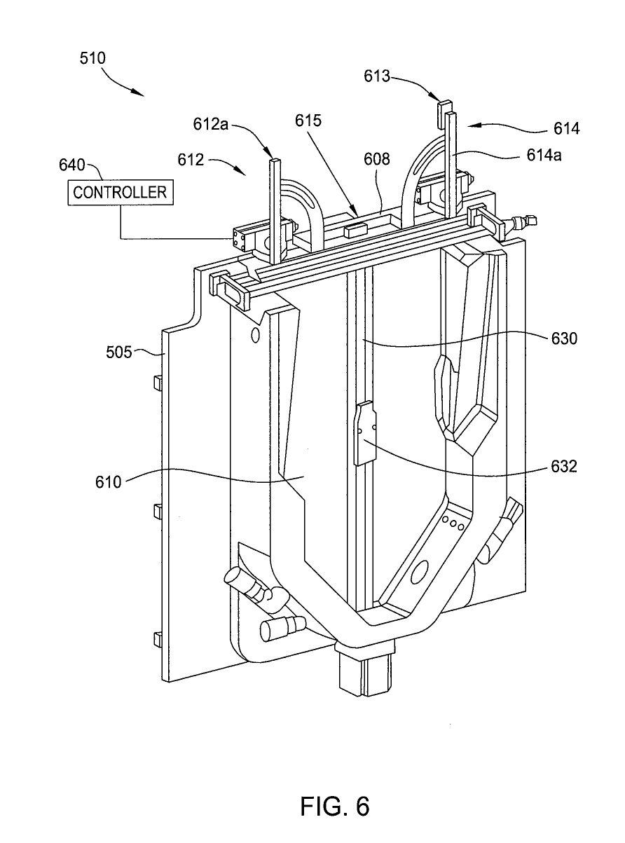

FIG. 6 is a cut-away perspective view of an embodiment of a drying module 510 as may be used in the apparatus of FIG. 5. The drying module 510 includes a support plate 505 having a top edge 608 coupled to a drying compartment 610 similar to and having corresponding features to the drying compartment shown in FIG. 2 and discussed above. Drying module 510 includes a pair of substrate input/output guides 612, 614 that are coupled to the top edge 608 of the support plate 505 above the drying compartment 610 and are spaced apart in the horizontal direction by approximately the diameter of a substrate. In some embodiments, each input/output guide 612, 614 may include a pivotable member 612a, 614a having a v-shaped, u-shaped or other surface for contacting a lateral edge of the substrate 310. The pivotable members 612a, 614a may be actuated, for example, by a controller 640. Each input/output guide 612, 614 may also comprise other features or mechanisms, such as a stop for limiting movement of the pivotable members 612a, 614a and/or any other feature suitable for securing a substrate in a vertical position over the drying compartment 610. A sensor 613 may be supported and/or positioned on a fixed portion of the input/output guides 612, 614 (e.g., to detect a position of the pivotable members 612a, 614a and/or a substrate supported by the pivotable members 612a, 614a). Additional sensors, e.g., sensor 615, may be positioned in other convenient locations to detect, for example, the presence of a substrate. A movable carrier device 632 is positioned on a rail 630 within the drying compartment 610.

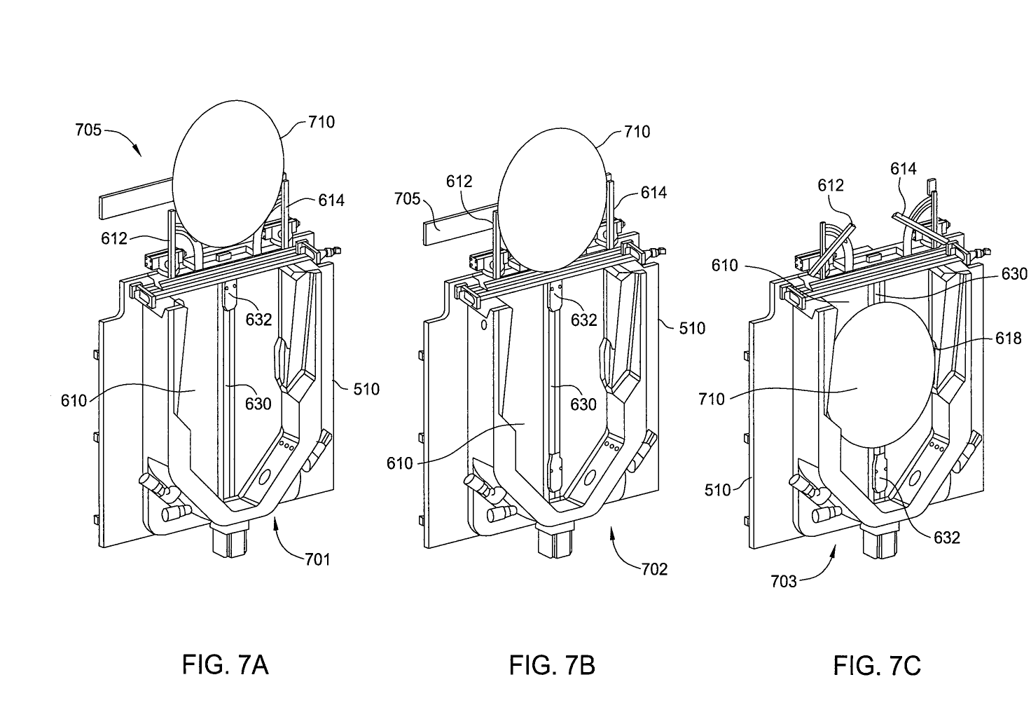

Operation of the drying module 510 during a substrate input process is described with reference to FIGS. 7A-7C which are perspective views. In a first stage 701 shown in FIG. 7A, a robot arm 705 holds a substrate 710 in a vertical orientation and moves the substrate to a position directly above the drying compartment 610. In this position the robot arm 705 positions the substrate adjacent the input/output guides 612, 614. In the next stage 702 shown in FIG. 7B, the robot arm 705 is moved downward and the carrier device 632 moves upward to the top of the rail 630 within the drying compartment 610. In this stage, the substrate 710 engages the input/output guides 612, 614 and is stabilized in lateral (horizontal) directions while the substrate's bottom edge comes into contact with the carrier device 632 so that it is also secured and stabilized vertically.

In stage 703 shown in FIG. 7C, the robot arm 705 (not shown) is disengaged from the substrate, the input/output guides 612, 614 pivot inwardly toward the top of the substrate 710 as the substrate 710 descends, directing the substrate 710 such that its edge enters guide 618 (which is visible only on the right side). The carrier 10 device 632 is moved downward along the rail 630 bringing the substrate downward with the carrier device 632 (e.g., under the force of gravity). In this manner the substrate 710 reaches a bottom position within the drying compartment 610 where the substrate 701 may be submerged in rinsing fluid.

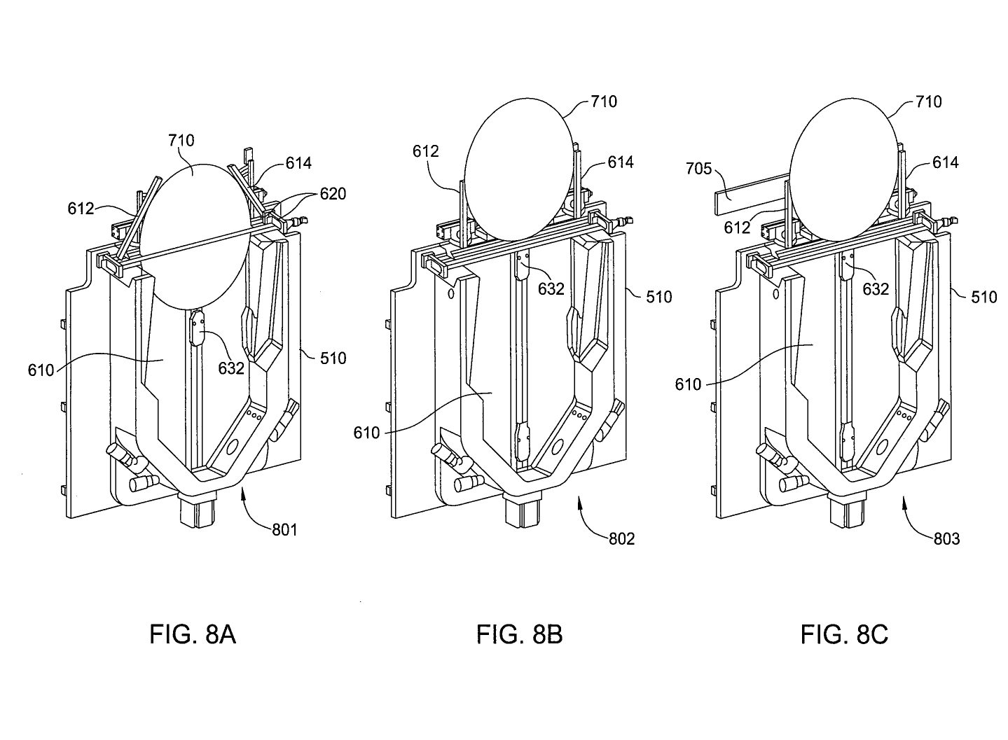

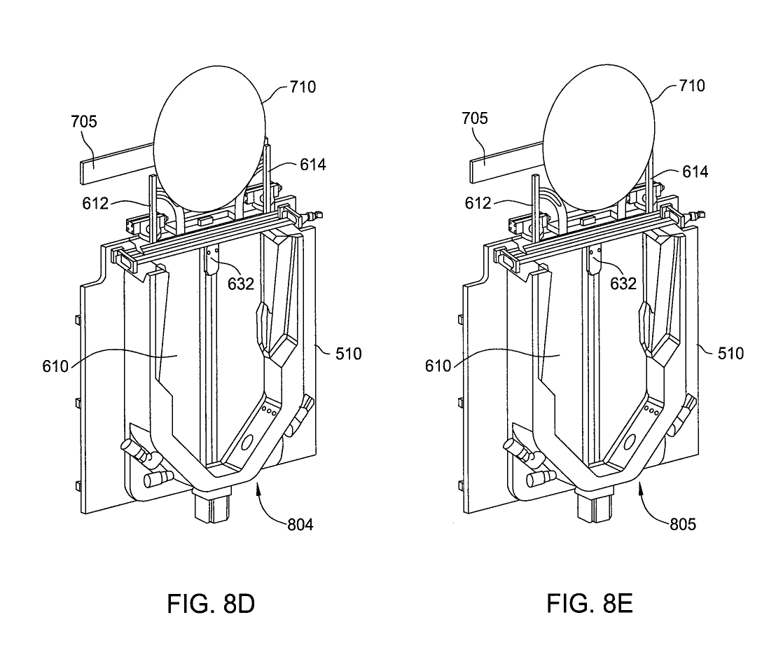

A substrate removal process sequence is shown in FIGS. 8A-8D, which are perspective views. In a first stage 801 shown in FIG. 8A, the substrate is lifted by the carrier device 632 and emerges from the drying compartment 610. As the substrate 710 emerges, drying vapor from conduits 620 is applied to the substrate 710 to reduce surface tension of the rinsing fluid (as previously described with reference to conduits 220 above). The substrate engages the input/output guides 612, 614 after it clears the top of the drying compartment 610 by a predefined distance. In some embodiments, the input/output guides 612, 614 may exert a slight constraining force against the lifting to help stabilize the substrate 710 as it is lifted (before it is secured by the robot arm 705 (not shown)). In the following stage 802 shown in FIG. 8E, the carrier device 632 reaches its top position and the substrate is lifted fully out of the drying compartment 610. The input/output guides 612, 614 are pivoted to a vertical position to prevent lateral movement while the carrier device 632 supports the substrate from underneath. In stage 803 shown in FIG. 8C, the robot arm 705 enters the apparatus 500 and securely engages the substrate 710. In stage 804 shown in FIG. 8D, the guides 612, 614 separate laterally to release the substrate 710, the robot arm 705 moves upward, and the substrate 710 is disengaged from the input/output guides 612, 614. In the following stage 805, shown in FIG. 8E, the robot arm 705 shifts forward in Direction 1 to completely clear the input/output guides 612, 614 and removes the substrate from the drying module 610 by carrying the substrate 710 in Direction 2.

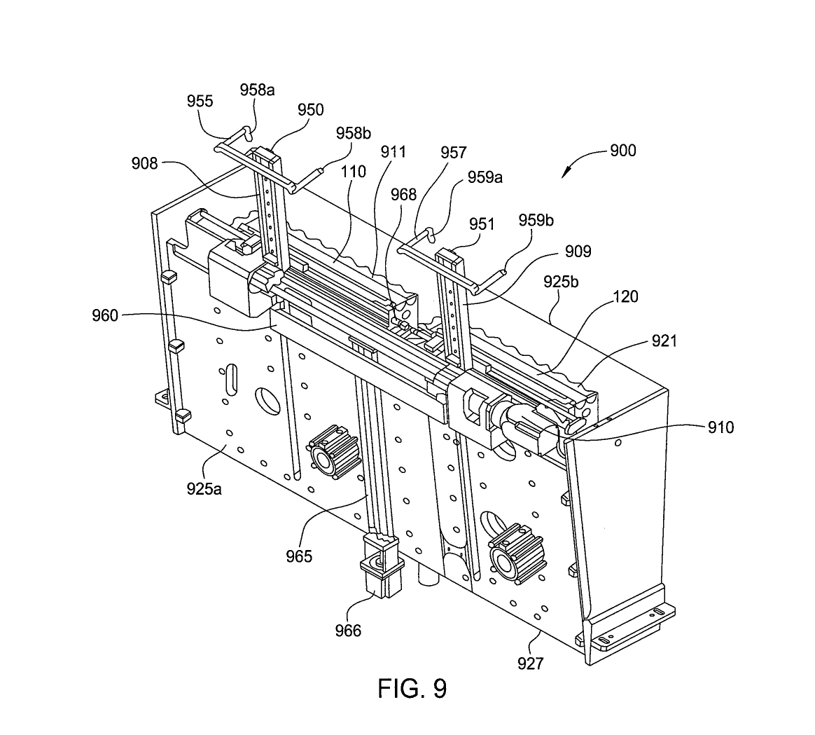

FIG. 9 is a perspective view of an embodiment of a multiple substrate drying apparatus 900 according to an embodiment of the present invention. The apparatus 900 includes another possible arrangement of the two vertically arranged drying modules 110, 120, positioned adjacent each other. In the depicted embodiment, the drying modules 110, 120 are side-by-side such that the respective frontal portions 911, 921 of the drying modules are parallel to each other, and the respective rear portions (not shown) of the drying modules are parallel to each other. The modules 110, 120 may be slightly angled with respect to a vertical axis, for example, between 1 and 1.5 degrees from vertical in some embodiments, and up to 8 to 10 degrees in other embodiments using a single drive dual tilt assembly 910. While the embodiment depicted illustrates depicts a dual (two) module drying apparatus, more than two drying modules may be used. The apparatus 900 includes sidewalls 925a-b and a bottom 927. The drying modules 110, 120 are mounted to sidewall 925a and the bottom 927. In some embodiments, the sidewall 925a may serve as just a mounting surface, which in other embodiments, the sidewall 925a may serve as the rear sealing surface of each module 110, 120.

Substrate sensors 950, 951 may be coupled to the sidewall 925a, such as via support members 908, 909 respectively. The sensors 950, 951 may comprise an infrared sensor or other suitable sensor adapted to determine whether a substrate surface is positioned in front of or in the vicinity of the sensors. In some embodiments, the substrate sensors 950, 951 may be rotatable between a vertical, active position and a horizontal, inactive position.

Gripping mechanisms 955, 957 adapted to grip an edge of a substrate also may be coupled to the sidewall 925a and/or the support members 908, 909 (see, for example, gripper 255 coupled to sidewall 125b in FIG. 1). The gripping mechanisms 955, 957 may comprise one or more pads, pincers or other gripping surfaces 958a-b, 959a-b respectively, for contacting and/or supporting a substrate being loaded into or unloaded from the drying compartments (as described above). In some embodiments, the gripping mechanisms 955, 957 (and gripping surfaces 958a-b, 959a-b) may be adapted to move vertically (via a motor), using the single drive dual lifter assembly 960 which travels via rail 965 or other guide, as a substrate is raised or lowered relative to the drying compartment. The dual drive lifter assembly 960 may be raised and lowered by motor 966. Both drying modules 110, 120 may be serviced by a single input dual spray manifold 968.

The present invention provides higher throughput and cost savings. Multiple substrate drying modules may be arranged in a small area, saving tool and/or instrument space, and providing advantages of a batch-like system, while allowing control and processing of individual substrates. A single robot may serve multiple modules, without requiring a running beam and/or working beam (e.g., as the robot movements are mostly vertical). In some embodiments, the modules are oriented approximately vertically (with about a 1 to 1.5 degree tilt from vertical, although larger or smaller tilts may be used, such as about up to 8 to 10 degrees), to improve Marangoni drying and/or system/module throughput.

The foregoing description discloses only exemplary embodiments of the invention. Modifications of the above disclosed apparatus and methods which fall within the scope of the invention will be readily apparent to those of ordinary skill in the art. For instance, other configurations for securing a substrate during loading into or unloading from a drying module may be employed.

Accordingly, while the present invention has been disclosed in connection with specific embodiments thereof, it should be understood that other embodiments may fall within the spirit and scope of the invention, as defined by the following claims.

1. A system for drying semiconductor substrates comprising:
a housing;
a first drying module positioned within the housing; and
a second drying module positioned adjacent the first drying module within the housing, wherein the first and second drying modules are oriented approximately vertically within the housing.

2. The system of claim 1, wherein the first and second drying modules are mirrored such that the respective frontal portions of the drying modules face each other.

3. The system of claim 1, wherein the first module and the second module are angled between 1 and 1.5 degrees with respect to a vertical axis.

4. The system of claim 1, wherein the housing comprises sidewalls and a bottom to which the drying modules are mounted.

5. The system of claim 1, wherein the first vapor drying module comprises a drying compartment that has width and depth dimensions that define sufficient internal volume to hold a rinsing fluid and a substrate of a desired size to be dried.

6. The system of claim 5, wherein the drying compartment comprises two lateral surfaces including an approximately vertically oriented groove adapted to receive substrate guides.

7. The system of claim 5, wherein the drying compartment comprises a backwall including a vertical rail along which a movable carrier device is adapted to move upward or downward.

8. The system of claim 4, further comprising one or more vapor conduits positioned above the drying compartment and coupled to the sidewall.

9. The system of claim 9, wherein the vapor conduits are oriented horizontally to cover the horizontal width of the drying compartment.

10. The system of claim 7, further comprising a gripping mechanism adapted to grip an edge of a substrate, wherein the gripping mechanism is coupled to the sidewall.

11. A system for drying semiconductor substrates comprising:
a housing comprising at least one sidewall and a bottom;
a first drying module positioned within the housing; and
a second drying module positioned adjacent the first drying module within the housing, wherein the first and second drying modules are oriented approximately vertically within the housing and side-by-side such that the respective frontal portions of the drying modules are parallel to each other, and the respective rear portions of the drying modules are parallel to each other.

12. The system of claim 11, wherein the first vapor drying module comprises a drying compartment that has width and depth dimensions that define sufficient internal volume to hold a rinsing fluid and a substrate of a desired size to be dried.

13. The system of claim 12, wherein the drying compartment comprises two lateral surfaces including an approximately vertically oriented groove adapted to receive substrate guides.

14. The system of claim 12, wherein the drying compartment comprises a backwall including a vertical rail along which a movable carrier device is adapted to move upward or downward.

15. The system of claim 12, further comprising one or more vapor conduits positioned above the drying compartment and coupled to the sidewall.

16. The system of claim 15, wherein the vapor conduits are oriented horizontally to cover the horizontal width of the drying compartment.

17. The system of claim 11, wherein the first module and the second module are angled between 1 and 1.5 degrees with respect to a vertical axis.
